(19) United States
(12) Patent Application Publication
(10) Pub. No.: US 2009/0023474 A1
(43) Pub. Date: Jan. 22, 2009

(54) TOKEN-BASED DYNAMIC AUTHORIZATION MANAGEMENT OF RFID SYSTEMS

(75) Inventors: XUN LUO, Cicero, IL (US); Krishna D. Jonnalagadda, Algonquin, IL (US); Francesca Schuler, Des Plaines, IL (US)

Correspondence Address: DILLON & YUDELL, LLP, 8911 NORTH CAPITAL OF TEXAS HWY., SUITE 2110, AUSTIN, TX, 78759, US

(73) Assignee: MOTOROLA, INC., SCHAUMBERG, IL (US)

(21) Appl. No.: 11/779,683

(22) Filed: Jul. 18, 2007

(51) Int. Cl. H04M 1/00

(52) U.S. Cl. 455/557

(57) ABSTRACT

A method of enabling a second RFID reader mobile phone to act as an agent for a first RFID reader mobile phone sends a token to the second RFID reader mobile phone. The token includes information associated with the first RFID reader mobile phone. The token may also include a token expiration time, which causes the token to be disabled at the end of the token expiration time. The information associated with the first RFID reader mobile phone may include an RFID tag identifier associated with the first RFID reader mobile phone. In other embodiments, the information associated with the first RFID reader mobile phone may include authenticating information.

### BACKGROUND OF THE INVENTION

The present invention relates generally to the field of near field communications (NFC), and more particularly to a method of enabling one radio frequency identification (RFID) reader mobile phone to act as an agent or proxy for another RFID reader mobile phone.

Near field communication using RFID tags and scanning devices is becoming common in a number of fields, such as electronic commerce and asset tracking. RFID tags are replacing bar coded labels. Manufacturers of mobile communication devices, such as cellular telephones, are including RFID readers or scanners in those devices. Accordingly, consumers will be able to track assets and make electronic commerce transactions using RFID-enabled mobile phones.

A problem with current near field communication in electronic commerce is that a consumer is typically uniquely associated with a particular mobile device. In order for the consumer to delegate purchasing authority to an agent or proxy, the consumer must give possession of the mobile device to the agent or proxy. Similarly, in asset tracking, a list or range of RFID tag serial numbers is typically associated with a mobile device. A mobile device cannot be used to locate RFID tags that are not included in its list or range of serial numbers. Thus, in order for a person to enable an agent or proxy to find an asset tagged with an RFID tag associated with the person's mobile device, the person must give possession of the mobile device to the agent or proxy.

### SUMMARY OF THE INVENTION

Embodiments of the present invention provide methods of enabling a second RFID reader mobile phone to act as an agent for a first RFID reader mobile phone. In one embodiment of the present invention, the first RFID reader mobile phone sends a token to the second RFID reader mobile phone. The token includes information associated with the first RFID reader mobile phone that enables the second RFID mobile phone to act as an agent or proxy for the first RFID reader mobile phone. The token may also include a token expiration time. The token expiration time causes the token to be disabled at the end of the token expiration time.

In some embodiments of the present invention, the information associated with the first RFID reader mobile phone includes an RFID tag identifier associated with the first RFID reader mobile phone. The token enables the second RFID reader mobile phone to locate the RFID tag identified by the identifier. In other embodiments of the present invention, the information associated with the first RFID reader mobile phone includes authenticating information. The token enables the second RFID reader mobile phone to establish an authenticated session with party such as a financial institution on behalf of the first RFID reader mobile phone. During such an authenticated session, the second RFID reader mobile phone can make a financial transaction, such as the purchase of an RFID-tagged item, for the first RFID reader mobile phone.

### BRIEF DESCRIPTION OF THE DRAWINGS

FIG. 1 is a block diagram of an embodiment of the present invention.

FIG. 2 is a block diagram of a second embodiment of the present invention.

FIG. 3 is a block diagram of an RFID reader mobile phone.

FIG. 4 is an illustration of a token according to an embodiment of the present invention.

FIG. 5 is an illustration of a token according to a second embodiment of the present invention.

FIG. 6 is a call flow diagram of an embodiment of the present invention.

FIG. 7 is a flow chart of an embodiment of processing according to the present invention.

FIG. 8 is a call flow diagram of a second embodiment of the present invention.

FIG. 9 is a flow chart of a second embodiment of processing according to the present invention.

### DETAILED DESCRIPTION

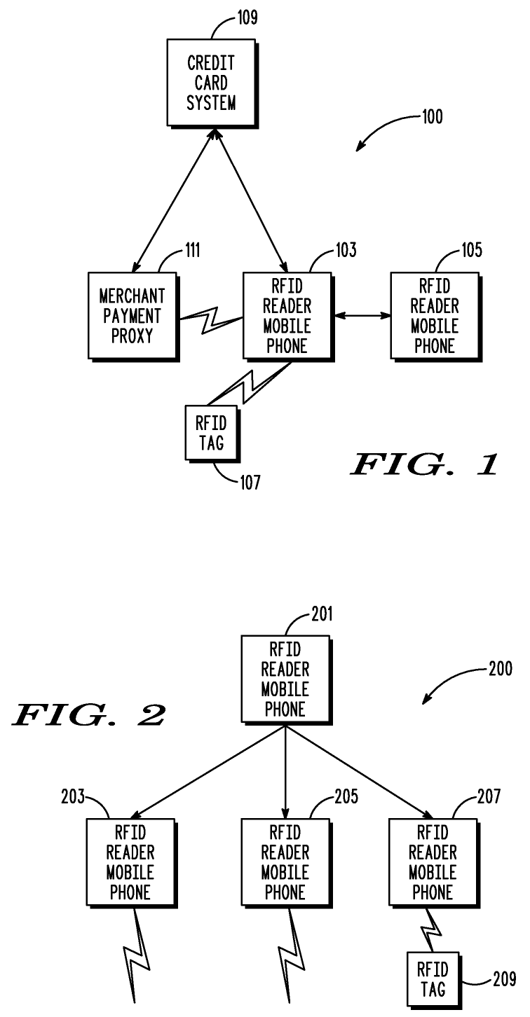

Referring now to the drawings, and first to FIG. 1, a system according to one embodiment of the present invention is designated generally by the 100. System 100 enables an RFID reader cell phone 103 to act as an agent for a principal RFID reader cell phone 105 in a three party transaction, such as the purchase of a product tagged with an RFID tag 107. For example, the owner of mobile phone 103 knows or is advised that the owner of mobile phone 105 wants to purchase a product of the type tagged by RFID tag 107. As will be explained in detail hereinafter, the owner of mobile phone 105 may provide to mobile phone 103 a token that enables phone 103, for a limited period of time, to act as an agent or proxy for mobile phone 105 to make the purchase. The token allows mobile phone 103 to interact with a credit card system indicated generally at 109. As is known to those skilled in the art of electronic commerce, credit card system 109 includes, among other things, a merchant bank, a credit card exchange, and a credit card issuer. System 100 also includes a merchant payment proxy 111 that communicates with credit card system 109 and mobile phone 103.

FIG. 2 illustrates an alternative embodiment of the present invention in which an RFID reader mobile phone 201 enables one or more RFID reader mobile phones 203-207 to act as its agent in locating an article tagged by an RFID tag 209. For example, the owner of mobile phone 201 has left at his or her office a file tagged with RFID tag 209. According to the embodiment of the present invention of FIG. 2, the owner of mobile phone 201 provides a token to mobile phone 203-207 that enables those phones to locate RFID tag 209.

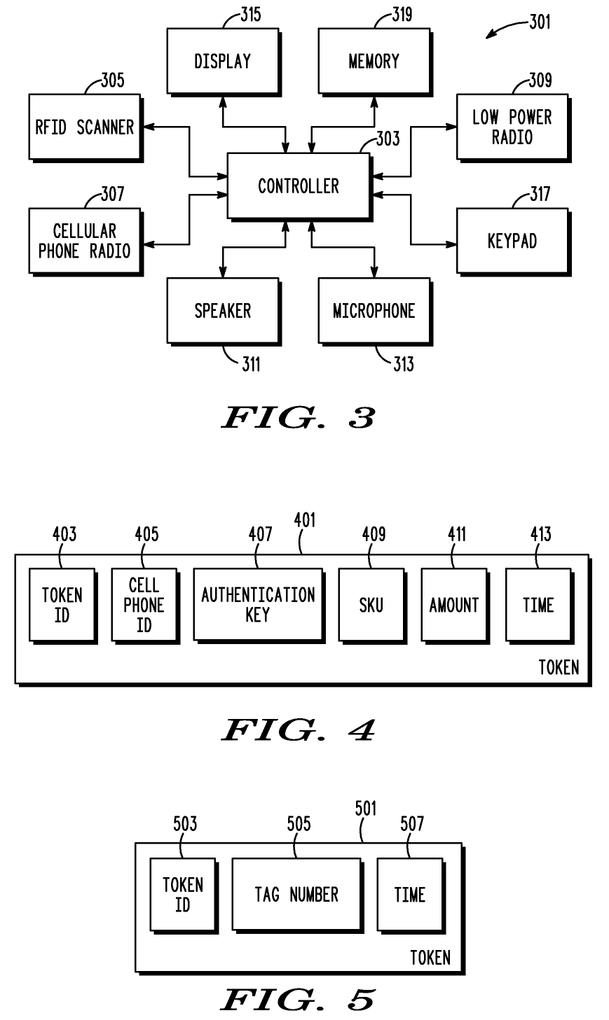

FIG. 3 is a block diagram of an RFID reader mobile phone 301 adapted to implement embodiments of the present invention. A controller 303 receives inputs from and provides outputs to various devices. Controller 303 includes a microprocessor (not shown) for executing various processes according to the present invention. RFID reader mobile phone 301 includes an RFID scanner 305. RFID reader mobile phone 301 also includes a cellular phone radio 307 and a short range low, power radio 309. Examples of short range radio protocols include Bluetooth, WiFi, Zigbee, etc. RFID scanner 305 enables a mobile phone 301 to obtain information from RFID tags, such as RFID tag 107 or RFID tagged 209 of FIGS. 1 and 2, respectively. Low power radio 309 enables mobile phone 301 to communicate with merchant payment proxy 111 of FIG. 1. RFID reader mobile phone 301 includes a speaker 311 and a microphone 313 coupled to controller 303. RFID reader mobile phone 301 also includes a display 315 and a keypad 317. Finally, memory 319 is coupled to controller 303.

FIG. 4 illustrates a token 401 that may be used in connection with the embodiment of FIG. 1. Token 401 includes a token ID 403, which identifies the transaction associated with token 401. As will be explained in detail hereinafter, a user may modify, cancel, or otherwise supersede a token by sending a new token having the same token ID. Token 401 includes a cell phone ID 405. Cell phone ID 405 is an identifier that uniquely identifies a mobile phone or its owner. For example, cell phone ID 405 may be an electronic serial number (ESN), an international circuit card ID (ICCID), an international mobile subscriber identity (IMSI), a bank account number, a credit card number, or the like. Token 401 also includes an authentication key 407 that is used in authenticating the authority of a mobile phone to make a transaction. Token 401 includes a product identifier, such as SKU 409, and an amount 411. SKU 409 and amount 411 may be obtained from an RFID tag associated with a product. Finally, tag 401 includes a time 413. Time 413 indicates the time at which token 401 will expire and become disabled.

FIG. 5 illustrates a token 501 that may be used in connection with the embodiment of FIG. 2. Token 501 includes a token ID 503. An RFID tag has a tag number that uniquely identifies it. An RFID reader typically has associated therewith a list or range of RFID tag numbers. The typical RFID reader can locate only those RFID tags having numbers associated with it. Token 501 includes a tag number 505 that identifies an RFID tag associated with a principal RFID reader mobile phone. Tag 501 also includes a time 507 that indicates the time at which token 501 will expire.

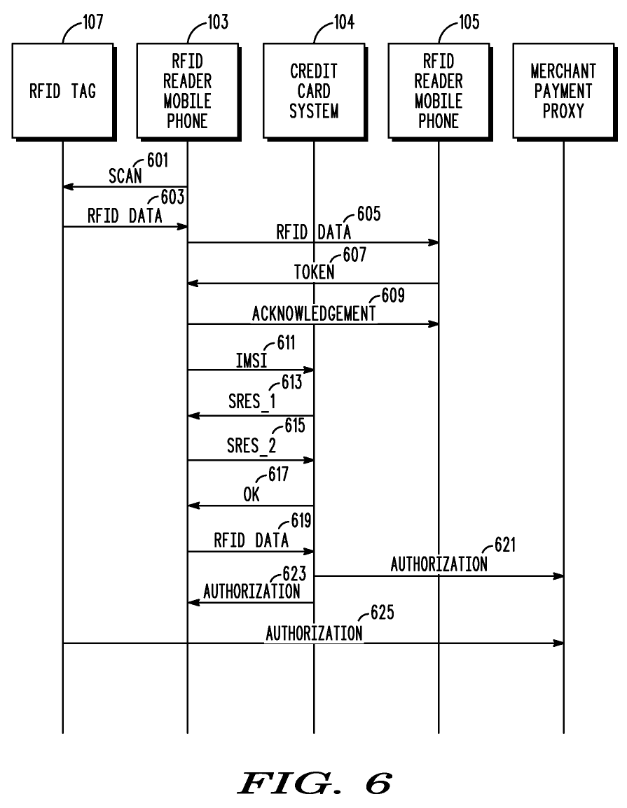

FIG. 6 is an information flow diagram of a transaction of FIG. 1. Agent RFID reader mobile phone 103 scans RFID tag 107, as indicated at 601. RFID tag 107 sends RFID data 603 back to agent RFID reader mobile phone 103. Then, agent RFID reader mobile phone 103 sends RFID data 605 to principal RFID reader mobile phone 105. Principal RFID reader mobile phone 105 creates a token of the type illustrated in FIG. 4 and sends the token 607 back to agent RFID reader mobile phone 103. For example, a user in a voice call can send the token through a single click to the person they are on a voice call with or text messaging. A user can attribute authentication and token capability in his or her contacts list or phone book to specific people and, upon selecting a phone book entry, the authentication/security can be generated and the appropriate data added to the token. Agent RFID reader mobile phone 103 may send an acknowledgment 609 back to principal RFID reader mobile phone 105. Agent REID reader mobile phone 103 then establishes a secure session with credit card system 109. RFID reader mobile phone 103 sends its ISMI 611 to credit card system 109. Credit card system 109 searches a database for the incoming ISMI 611 and its associated authentication key. Credit card system 109 then generates a random number and signs it by computing another number using the authentication key. The number computed by the credit card company is known as a signed response (SRES_1) 613. RFID mobile phone 103 signs SRES_1 613 with its authentication key and sends its signed response (SRES_2) 615 back to credit card system 109. Credit card system 109 then compares SRES_1 and SRES_2. If they match, the session is authenticated and credit card system 109 sends an OK message back to agent RFID reader mobile phone 103. Then, agent RFID reader mobile phone 103 sends RFID data 619, including the product identifier and the selling price, including any sales tax, to credit card system 109. Credit card system 109 determines whether or not to complete the transaction. If credit card system 109 completes the transaction, it sends and authorization 621 to merchant proxy 111 and authorization 623 to agent RFID reader mobile phone 103. Then, agent RFID reader mobile phone 103 provides authorization 625 to merchant payment proxy 111. If authorizations 621 and 625 match each other, the transaction is completed.

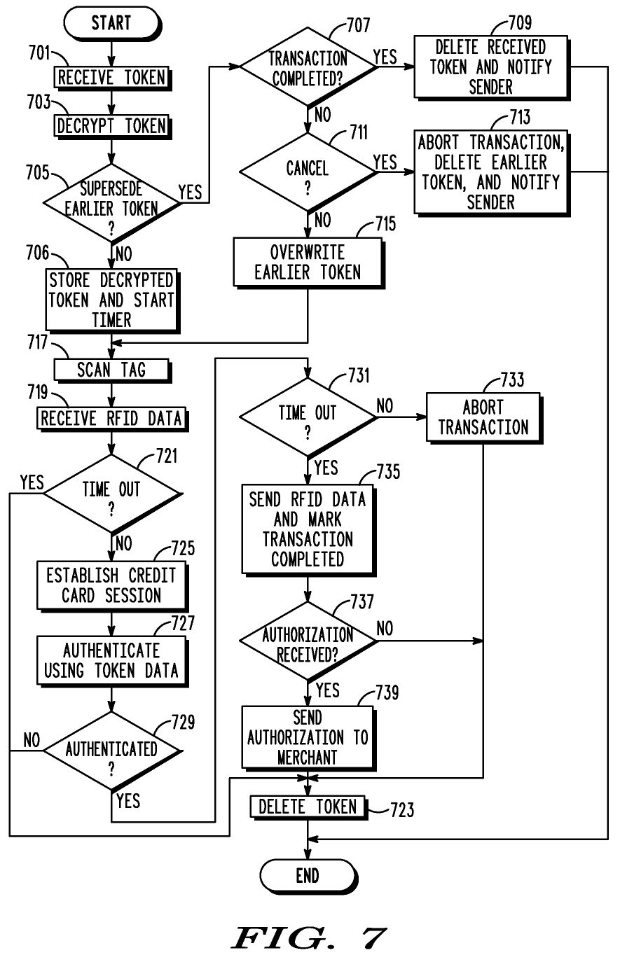

FIG. 7 is a flow chart of agent RFID reader mobile phone processing according to the embodiment of FIG. 1. The agent RFID reader mobile phone receives a token, at block 701. Preferably, the token is encrypted. The agent RFID reader mobile phone decrypts the token, at block 703. Then, the agent RFID reader mobile phone determines, at decision block 705, if the received token supersedes an earlier token. A sender may send a superseding token to change the item to be purchased or the price to be paid for the item, or to cancel the purchase, or withdraw authority to make the transaction, or for any other reason. The agent RFID reader mobile phone determines if the received token supersedes an earlier token by comparing the token ID, described in connection with FIG. 4, of the received with the token IDs of stored or pending tokens. A received token supersedes an earlier token if the two tokens have matching token IDs. If the received token does not supersede an earlier token, the agent RFID reader mobile phone stores the decrypted token and starts a timer, at block 706. The timer is set to the value of the time field 413 of token 401 of FIG. 4. If the received token supersedes an earlier token, the agent RFID reader mobile phone determines if the transaction associated with the token is completed, at decision block 707. If so, the agent RFID reader mobile phone deletes the received token and notifies the sender, at block 709. If the transaction has not been completed, the agent RFID reader mobile phone determines, at decision block 711, if the received token cancels the transaction of the earlier token. If so, the agent RFID reader mobile phone aborts the transaction, deletes the earlier token, and notifies the sender, at block 713. If the received token does not cancel the transaction of the earlier token, the agent RFID reader mobile phone overwrites the earlier token, at block 715.

After storing, at block 706, or overwriting, at block 715, the token, the next step is scanning a tag, at block 717, and receiving RFID data, at block 719. The RFID reader mobile phone determines, at decision block 721, if the timer has timed out. If so, the token is no longer valid and the RFID reader mobile phone deletes the token, as indicated at block 723, and processing ends. If, as determined, at decision block 723, the RFID reader mobile phone receives the RFID data before the timer times out, the RFID reader mobile phone establishes a credit card session, at block 725. The RFID reader mobile phone performs authentication using token data, as indicated at block 727. If, as determined at decision block 729, the session is not authenticated, the token is deleted from memory, at block 725, and processing ends. If the session is authenticated, then the RFID reader mobile phone determines, at decision block 731, if the RFID data matches the token data, at least with respect to the product identifier and the amount. If not, the RFID reader mobile phone aborts the transaction, at block 733, deletes the token, at block 723, and processing ends. If the RFID data matches the token then the RFID reader mobile phone sends the RFID data to the credit card system and marks the transaction completed, at block 735. If, as determined at decision block 737, authorization is not received, the token is deleted, at block 723, and processing ends. If, as determined at decision block 737, the RFID reader mobile phone receives authorization, the RFID reader mobile phone sends the authorization to the merchant proxy, as indicated at block 739. Then the token is deleted, at block 723, and processing ends.

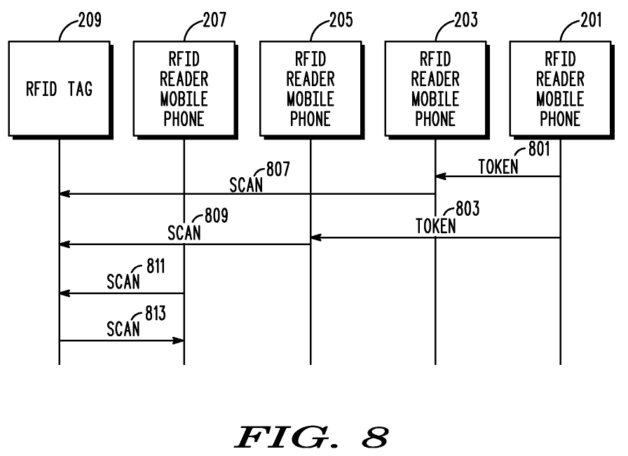

FIG. 8 is a flow diagram of the embodiment of FIG. 2. Principal RFID reader mobile phone 201 sends tokens 801-805 of the type illustrated in FIG. 5 to RFID reader mobile phones 203-207, respectively. Using tag number 503 of token 501, RFID reader mobile phones 203-207 each scan 811, respectively, looking for RFID tag 209. In response to scans 807-811, RFID tag 209 responds by sending RFID data 813 to RFID reader mobile phone 207.

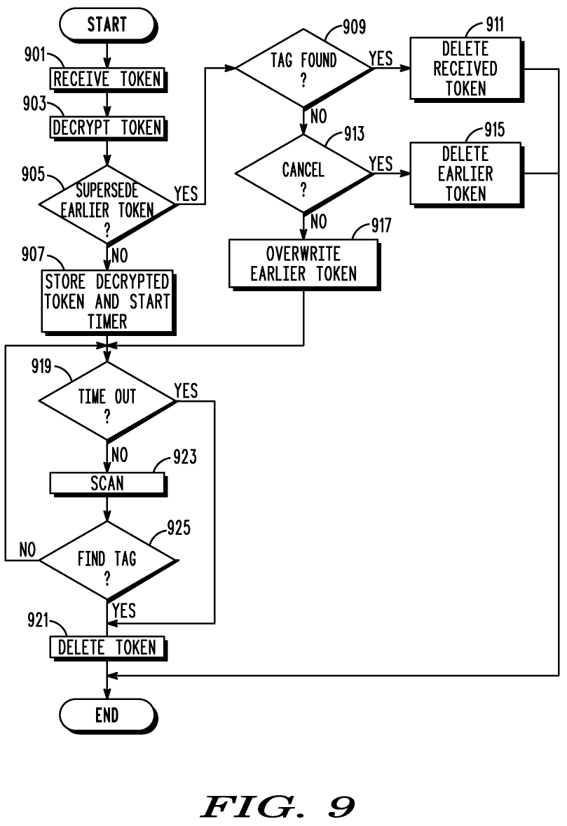

FIG. 9 is a flow chart of agent RFID mobile phone processing according to the embodiment of FIG. 2. The RFID reader mobile phone receives a token, at block 901. The RFID reader mobile phone decrypts the token, at block 903, and determines, at decision block 905, if the received token supersedes an earlier token. A sender may send a superseding token if, for example, the tag has been found or misidentified. If the received token does not supersede an earlier token, the RFID reader mobile phone and stores the decrypted token and starts its timer, at block 905. If the received token supersedes an earlier token, the agent RFID reader mobile phone determines if the RFID tag associated with the token has been found, at decision block 909. If so, the agent RFID reader mobile phone deletes the received token, at block 911. If the tag has not been found, the agent RFID reader mobile phone determines, at decision block 913, if the received token cancels the search for the tag of the earlier token. If so, the agent RFID reader mobile phone deletes the earlier token, at block 915. If the received token does not cancel the search of the earlier token, the agent RFID reader mobile phone overwrites the earlier token, at block 917.

The RFID reader mobile phone then determines, at decision block 919, if the timer has timed out. If so, the RFID reader mobile phone deletes the token, at block 921, and processing ends. If the timer has not timed out, then the RFID reader mobile phone performs a scan, at block 923. If, as determined, at decision block 925, the tag is not found, processing returns to decision block 919. If, at decision block 925, the tag is found, the RFID reader mobile phone deletes the token and processing ends. Processing according to FIG. 9 continues until all the timer times out or the tag is found.

From the foregoing, it may be seen that embodiments of the present invention are well adapted to overcome the shortcomings of the prior art. The present invention provides convenient and secure methods of enabling one RFID reader mobile phone to act as an agent for another RFID reader mobile phone. The present invention has been described with reference to presently preferred embodiments. Those skilled in the art, given the benefit of this disclosure, will recognize alternative embodiments. Accordingly, the foregoing description is intended for purposes of illustration and not limitation.

What is claimed is:

1. A method of enabling a second RFID reader mobile phone to act as an agent for a first RFID reader mobile phone, which comprises:
creating a token, said token including information associated with said first RFID enabled mobile phone and a token expiration time.

2. The method as claimed in claim 1, further comprising:
transmitting said token to said second RFID reader mobile phone.

3. The method as claimed in claim 2, further comprising:
scanning an RFID tag.

4. The method as claimed in claim 2, further comprising:
using said token to make a transaction.

5. The method as claimed in claim 4, wherein said transaction includes:
locating an RFID tag.

6. The method as claimed in claim 4, wherein said transaction includes:
purchasing an RFID-tagged product.

7. The method as claimed in claim 4, wherein said transaction includes a financial transaction.

8. The method as claimed in claim 1, wherein said information associated with said first RFID reader mobile phone comprises:
an RFID tag identifier.

9. The method as claimed in claim 1, wherein said information associated with said first RFID reader mobile phone comprises:
an identifier that identifies said first RFID enabled mobile phone.

10. The method as claimed in claim 9, wherein said information associated with said first RFID reader mobile phone comprises:
an encryption key associated with said identifier.

11. The method as claimed in claim 1, wherein said token further includes:
a monetary authorization amount.

12. The method as claimed in claim 1, wherein said token further includes:
a product identifier.

13. The method as claimed in claim 1, wherein said token further includes:
financial institution information.

14. The method as claimed in claim 1, further comprising:
disabling said token.

15. The method as claimed in claim 14, wherein said token is disabled after said token expiration time.

16. The method as claimed in claim 14, wherein said token is disabled in response to a revocation.

17. The method as claimed in claim 1, wherein said information associated with said first RFID reader mobile phone includes:
a digital signature.

18. A method of enabling a second RFID reader mobile phone to act as an agent for a first RFID reader mobile phone, which comprises:
sending to said second RFID reader mobile phone a token, said token including information associated with said first RFID enabled mobile phone.

19. The method as claimed in claim 18, wherein said token further includes:
a token expiration time.

20. The method as claimed in claim 19, further comprising:
disabling said token in response to expiration of said token expiration time.

21. The method as claimed in claim 18, wherein said information associated with said first RFID reader mobile phone includes:
an RFID identifier associated with said first RFID reader mobile phone.

22. The method as claimed in claim 18, wherein said information associated with said first RFID reader mobile phone includes:
authenticating information associated with said first RFID reader mobile phone.

23. The method as claimed in claim 22, wherein said authenticating information includes:
a unique identifier.

24. The method as claimed in claim 22, wherein said authenticating information includes:
an encryption key.

25. The method as claimed in claim 22, wherein said authenticating information includes:
a digital signature.

26. The method as claimed in claim 18, further comprising:
disabling said token in response to a revocation.

27. The method as claimed in claim 18, further comprising:
storing said token in said second RFID reader mobile phone; and,
using said information of said to token to perform an operation on behalf of said first RFID reader mobile phone with said second RFID reader mobile phone.

28. The method as claimed in claim 27, further comprising:
sending to said second RFID reader mobile phone a superseding token.

29. The method as claimed in claim 28, further comprising:
determining if said operation has been performed.

30. The method as claimed in claim 29, further comprising:
superseding said token if said operation has been not been performed.

31. The method as claimed in claim 30, wherein said superseding comprises modifying information in said token.

32. The method as claimed in claim 30, wherein said superseding comprises revoking said token.

33. The method as claimed in claim 32, wherein said revoking comprises deleting said token from said second RFID reader mobile phone.
